(19) United States
(12) Patent Application Publication
(10) Pub. No.: US 2005/0074543 A1
(43) Pub. Date: Apr. 7, 2005

(54) Method of coating an SLA part

(76) Inventors: Randal A. Stevens, Hanover, MN (US); Sid C. Insixiengmay, Minneapolis, MN (US)

Correspondence Address: BRIGGS AND MORGAN, P.A., 2200 IDS CENTER, MINNEAPOLIS, MN, 55402, US

(21) Appl. No.: 10/680,453

(22) Filed: Oct. 7, 2003

(51) Int. Cl. B05D 3/06

(52) U.S. Cl. 427/2.1; 427/558

(57) ABSTRACT

A method for producing a high gloss exterior finish on a hearing aid ear shell. The method consists of the steps of: coating the ear shell with a UV-curable substance and/or a stereo-lithography resin; draining the UV-curable substance off the ear shell; exposing the ear shell to UV light to cure the UV-curable substance; removing any excess of the UV-curable substance; and exposing the UV-curable substance to UV light a second time.

### BACKGROUND OF THE INVENTION

Stereo-lithography methods are presently being used to manufacture highly accurate hearing instrument ear shells over prior conventional pouring or UV methods. SLA methodology has two predominant resolution modes derived by how fine the stl file is sliced for processing. High resolution mode consists of building the part to be manufactured in either 0.002″/0.05 mm or 0.004″/0.10 mm layered thicknesses.

The layering process has a faceting or stair stepped effect on the completed ear shells exterior surfaces. The finer the slice thickness the less noticeable the effect is. Further more, this high resolution mode has proportionately longer build times as a result of twice the amount of layers processed. The present invention smoothens the faceted surfaces of the ear shell, allowing lower resolution mode, i.e. faster build times to be used while generating a high gloss finish.

Stereo-lithographic ear shells manufactured without additional post secondary treatments such as air abrading, polishing and sanding have an acceptably smooth matte finish in high resolution mode. However, hearing instrument manufactures have experienced that matte finishes tend to more readily display build up of cerumen (ear wax), dirt and perspiration that can often discolor the appearance of the ear shell. As a result it is thought to be more frequently needed to disinfect and clean ear shells having matte finishing.

High gloss ear shell finishes achieved using other conventional methods, such as polishing or buffing, add direct labor and experienced skill sets to create a uniform finish without excessively removing material. Conventional buffing and polishing methods create inconsistencies in the rate of material removal and vary by operator skills and experience. Test studies indicate geometry changes by as much as 0.030″/0.762 mm-0.050″/1.27 mm occur when using these conventional finishing techniques. This leads to poor customer satisfaction as a result of poor fitting, comfort, retention and acoustic feedback due to loose or inadequate aperture sealing within the inner ear.

Air abrading and or vibratory polishing methods are also less accurate at producing a smooth surface without losing the accuracy benefits of stereo-lithography ear shells.

The high gloss finish achieved using this invention creates a uniform covering of the ear shell geometry without loss of accuracy, smoothing the residual faceting created by the stereo-lithographic layering process.

### SUMMARY OF THE INVENTION

A method of producing a high gloss exterior finish on a hearing aid ear shell, the ear shell having a vent, comprising the steps of:

(a) coating the ear shell with a UV-curable substance;

(b) permitting the UV-curable substance to drain off the ear shell, leaving a thin uncured layer on the ear shell;

(c) exposing the ear shell to UV light to cure the thin uncured layer;

(d) removing any excess of the UV-curable substance; and

(e) exposing the ear shell to UV light a second time.

An object and advantage of the present invention is that it permits the use of a lower resolution stereo-lithography mode to create the ear shell, thereby permitting faster build times for the ear shell.

Another principle object and advantage of the present invention is that the high gloss exterior finish is less susceptible to the build up of cerumen (ear wax), dirt, and perspiration on the ear shell.

Another principle object and advantage of the present invention is that the high gloss finish is produced without buffing or polishing the ear shell, thus saving labor.

Another principle object and advantage of the present invention is that avoiding buffing and polishing avoids removing material from the ear shell, thus preventing poor customer satisfaction due to poor fit, discomfort, poor retention, and acoustic feedback due to loose or inadequate aperture sealing with the inner ear.

Another principle object and advantage of the present invention is that the high gloss finish is produced without air abrading or vibratory polishing methods.

Another principle object and advantage of the present invention is that it can be performed by less skilled operators than are needed for other methods, such as buffing, polishing, air abrading, and vibratory polishing.

Another principle object and advantage of the present invention is that the same stereo-lithography resin used to manufacture the ear shell may be used to coat the ear shell, resulting in a seamless product.

### BRIEF DESCRIPTION OF DRAWINGS

FIG. 1 is a flowchart of the method of the present invention.

### DETAILED DESCRIPTION OF THE PREFERRED EMBODIMENT

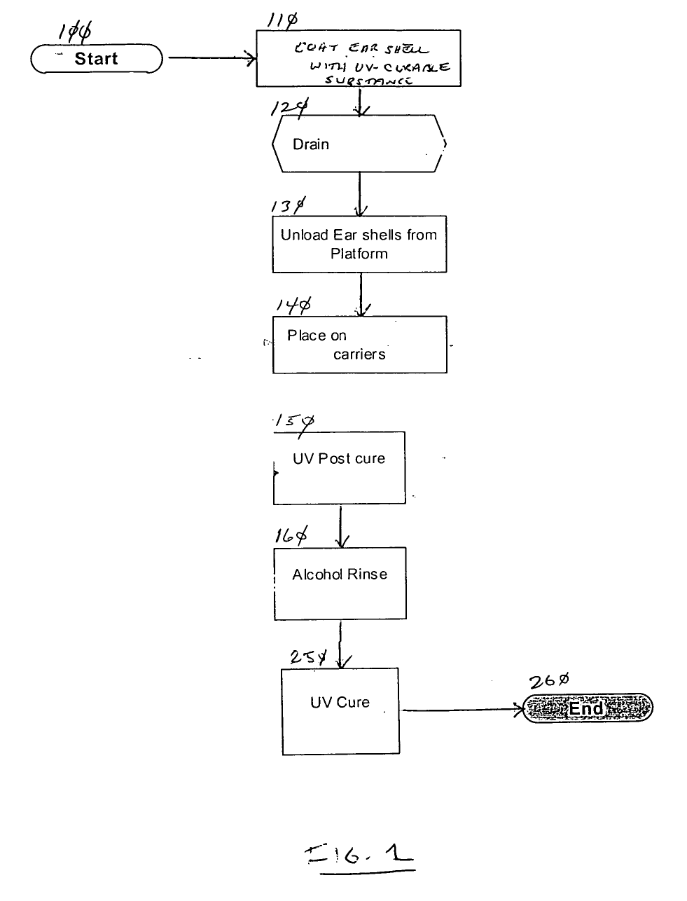

A flowchart of the present invention is shown in FIG. 1.

The method of the present invention comprises the steps of: a) coating the ear shell with a UV-curable substance (110); b) permitting the UV-curable substance to drain off the ear shell, leaving a thin uncured layer on the ear shell (120); c) exposing the ear shell to UV light to cure the thin uncured layer (130-150); d) removing any excess of the UV-curable substance (150-160); and e) exposing the ear shell to UV light a second time (250).

Preferably, the UV-curable substance further comprises a stereo-lithography (SLA) resin.

Since the coating process creates a new layer of resin on the SLA ear shell and is dependant on resin viscosity and temperature, tests have been conducted to calculate an offset value to negatively compensate shell wall thicknesses as needed to achieve desired final thickness requirements. This is typically 0.004″/0.10 mm but varies based on type of resin, viscosity and build temperature. Thus, the method further preferably comprises the step of pre-sizing the ear shell thickness to account for the increased thickness added by the process.

Resins and manufactures suitable for hearing aid ear shell applications:

3D Systems Inc. RPC 550ND

Dreve Otoplastik; Fototec

Vantico; Stereocol; LLS-71300; LLS-71410 (Visc window of 350-1000cps @30 deg C.)

Preferably, the step (d) of removing any excess of the UV-curable substance is performed by rinsing the ear shell in an alcohol bath. Most preferably, this includes exposure of the ear shell to ultrasound in the alcohol bath.

### EXPERIMENT 1

Hearing aid ear shells manufactured through stereo-lithography were placed on the platform of the SLA apparatus and submerged in the SLA resin. The platform was then raised, allowing the SLA resin to drain off the ear shells. The shells were allowed to drain for 5 to 10 minutes. Forceps were then used to grip the supports of the ear shells, and the ear shells were placed on a carrier and exposed to UV light for about 3 minutes. The ear shells were then placed in an ultrasound alcohol bath for about 2 minutes. The ear shells were then removed from the alcohol bath. Finally, the ear shells were cured in UV light for an additional 30 minutes.

The resulting ear shells had a smooth, high gloss exterior finish. If a microscopic examination were to be made of the ear shell, the exterior would appear seamless, since the same SLA resin was used to coat the ear shells as was used to manufacture them.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1. A method of producing a high gloss exterior finish on a hearing aid ear shell, the ear shell having a vent, comprising the steps of:
(a) coating the ear shell with a UV-curable substance;
(b) permitting the UV-curable substance to drain off the ear shell, leaving a thin uncured layer on the ear shell;
(c) exposing the ear shell to UV light to cure the thin uncured layer;
(d) removing any excess of the UV-curable substance; and
(e) exposing the ear shell to UV light a second time.

2. The method of claim 1, wherein the UV-curable substance further comprises a stereo-lithography resin.

3. The method of claim 1, further comprising the step of pre-sizing the ear shell thickness to account for increased thickness added by steps (a) through (f).

4. The method of claim 1, wherein the step (d) is performed by rinsing the ear shell in an alcohol bath.

5. The method of claim 5, wherein the step (d) is performed with exposure of the ear shell to ultrasound in the alcohol bath.

6. A method of producing a high gloss exterior finish on a hearing aid ear shell, the ear shell having a vent, comprising the steps of:
(a) pre-sizing the ear shell thickness to account for increased thickness added by steps (b) through (g);
(b) coating the ear shell with a UV-curable substance;
(c) permitting the UV-curable substance to drain off the ear shell, leaving a thin uncured layer on the ear shell;
(d) exposing the ear shell to UV light to cure the thin uncured layer;
(e) removing any excess of the UV-curable substance; and
(f) exposing the ear shell to UV light a second time.

7. The method of claim 6, wherein the UV-curable substance further comprises a stereo-lithography resin.

8. The method of claim 6, wherein the step (e) is performed by rinsing the ear shell in an alcohol bath.

9. The method of claim 8, wherein the step (e) is performed with exposure of the ear shell to ultrasound in the alcohol bath.

10. A method of producing a high gloss exterior finish on a hearing aid ear shell, the ear shell having a vent, comprising the steps of:
(a) pre-sizing the ear shell thickness to account for increased thickness added by steps (b) through (g);
(b) coating the ear shell with a stereo-lithography resin;
(c) permitting the stereo-lithography resin to drain off the ear shell, leaving a thin uncured layer on the ear shell;
(d) exposing the ear shell to UV light to cure the thin uncured layer;
(e) removing any excess of the stereo-lithography resin; and
(f) exposing the ear shell to UV light a second time.

11. The method of claim 11, wherein the step (e) is performed by rinsing the ear shell in an alcohol bath.

12. The method of claim 11, wherein the step (e) is performed with exposure of the ear shell to ultrasound in the alcohol bath.
